(19) United States
(12) Patent Application Publication
(10) Pub. No.: US 2008/0002276 A1
(43) Pub. Date: Jan. 3, 2008

(54) Method and apparatus for Contact Start-Stop hard disk drive actuator control during power cycles for improved reliability

(76) Inventors: Brian D. Strom, Cupertino, CA (US); Andrei Khurshudov, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/479,967

(22) Filed: Jun. 29, 2006

(51) Int. Cl. G11B 21/02

(52) U.S. Cl. 360/75

(57) ABSTRACT

Operating a contact start-stop Hard Disk Drive (HDD) by starting the disks through stimulating the Voice Coil Motor (VCM) to position slider(s) at a slider starting position away from dents and furrows resulting from non-operating mechanical shocks. Embedded circuits supporting operations and HDDs implementing them. Methods of manufacturing the embedded circuits and HDDs, and the manufacturing products of these processes.

### TECHNICAL FIELD

This invention relates to apparatus and methods of operating a Contact Start-Stop hard disk drive, especially after being damaged by mechanical shocks in a non-operational mode, when the sliders are parked on the disk surfaces of the hard disk drive.

### BACKGROUND OF THE INVENTION

The invention focuses on Contact Start-Stop (CSS) hard disk drives. From hereon, a hard disk drive will be assumed to be a CSS hard disk drive. These hard disk drives are faced with several problems, some of which occur while a hard disk drive is not operating as a memory access device, which will be known herein as its non-operational mode.

These hard disk drives sometimes experience shock events that propagate through them and cause their sliders to bounce away from the disks they are parked on. Inevitably, the sliders swing back toward the disk and impact the disk surface at one or more of the slider corners, which produce dents in the disk surface and may produce raised furrows around the dents. The disk substrates are often Ni—P clad aluminum. If the shock event occurs while the sliders are parked, which are known as non-operating shock, these dents and furrows are produced in the start-stop landing zone near the inside diameter.

During subsequent start-stop cycling, the sliders rub on these raised furrows while the disks accelerate to target speed when starting or decelerate to rest when stopping. Because contact pressures are high when rubbing on the raised furrows, these regions of the disk wear quickly, which exposes underlying metallic layers and often result in catastrophic failure. Moreover, the furrows are tall enough to interfere with the slider when at full speed, while the slider would otherwise be flying free of contact. These repeated high speed rubbing/impact events cause rapid damage.

Read-write head degradation is another failure mode associated with start-stop cycling after non-operating shock damage. If the read-write head contacts the raised furrows around disk dents, it may be scratched or electrically shorted by smears of metal material worn from the disk.

### SUMMARY OF THE INVENTION

The invention focuses on Contact Start-Stop (CSS) hard disk drives. From hereon, a hard disk drive will be assumed to be a CSS hard disk drive. These hard disk drives are faced with several problems, some of which occur while a hard disk drive is not operating as a memory access device, which will be known herein as its non-operational mode.

The invention operates a hard disk drive by starting at least one disk using a starting stimulus presented to a voice coil driver to create a voice coil control signal supplied to the voice coil motor to push at least one slider to a slider starting position from a slider parked position. The invention improves contact start-stop durability for hard disk drives, especially for hard disk drives damaged by non-operating shock. It improves CSS durability and decrease the probability of read-write head degradation resulting from start-stop cycling after non-operating shock damage for hard disk drives where the slider is normally positioned directly over the dents and their furrows in the landing zone.

The invention may further include stopping the at least one disk using a stopping stimulus presented to the voice coil driver to drive the voice coil control signal supplied to the voice coil motor to push the slider while the disk spindle decelerates to rest. Stopping the at least one disk may further include stopping the at least one disk using the stopping stimulus presented the voice coil driver to create the voice coil control signal supplied to the voice coil motor to push the slider toward the inside diameter to a slider stopping position from the slider parked position.

The distance between the slider starting position and the slider parked position may be at most one millimeter, and preferably about half millimeter. The distance between the slider stopping position and the slider parked position may be at most half millimeter and preferably about a quarter millimeter.

The invention includes an embedded circuit for operating the hard disk drive, including means for starting the disk using the starting stimulus presented to the voice coil driver to create the voice coil control signal, where the voice coil control signal is supplied to the voice coil motor to push the slider to the slider starting position from the slider parked position above a disk surface included in the disk.

The embedded circuit may further include means for stopping the using a stopping stimulus presented the voice coil driver to drive the voice coil control signal supplied to the voice coil motor to push the slider while the disk spindle decelerates to rest. The means for stopping may further preferably include means for stopping the disk using the stopping stimulus presented the voice coil driver to create the voice coil control signal supplied to the voice coil motor to push the slider toward the inside diameter to the slider stopping position from the slider parked position.

The embedded circuit may include an implementation of the means for starting including at least one of the following. A servo computer presenting the starting stimulus to the voice coil driver and accessibly coupled to a servo memory and directed by a servo program system including at least one program step residing in the servo memory. An embedded computer presenting the starting stimulus to the voice coil driver and accessibly coupled to an embedded memory and directed by an embedded program system including at least one program step residing in the embedded memory. A finite state machine presenting the starting stimulus to the voice coil driver. A neural network presenting the starting stimulus to the voice coil driver. And/or an inference engine presenting the starting stimulus to the voice coil driver.

The invention includes manufacturing the embedded circuit, by providing the means for starting to create the embedded circuit. Manufacturing may also include providing the means for stopping to further create the embedded circuit. The invention includes the embedded circuit as a product of this process.

Providing the means for starting may further include at least one of the following. Providing a servo computer presenting the starting stimulus to the voice coil driver and accessibly coupled to a servo memory and directed by a servo program system including at least one program step residing in the servo memory. Providing an embedded computer presenting the starting stimulus to the voice coil driver and accessibly coupled to an embedded memory and directed by an embedded program system including at least one program step residing in the embedded memory. Providing a finite state machine presenting the starting stimulus to the voice coil driver. Providing a neural network presenting the starting stimulus to the voice coil driver. And providing an inference engine presenting the starting stimulus to the voice coil driver.

Providing the servo computer may further include providing at least one of the program steps in a non-volatile memory component of the servo memory. Providing the embedded computer, may further include providing the at least program step in a non-volatile memory component of the embedded memory. As used herein a non-volatile memory component retains its memory contents with being provided with power, whereas a volatile memory component requires a supply of power on at least an irregular basis to retain its memory contents.

The servo program system and/or the embedded program system, may include a program step supporting starting the at least one disk using the starting stimulus presented to the voice coil driver to create the voice coil control signal supplied to the voice coil motor to push the at least one slider to the slider starting position from the slider parked position.

The servo program system and/or the embedded program system, may include a program step supporting stopping the using a stopping stimulus presented the voice coil driver to drive the voice coil control signal supplied to the voice coil motor to push the slider while the disk spindle decelerates to rest, possibly further supporting stopping the disk using the stopping stimulus presented the voice coil driver to create the voice coil control signal supplied to the voice coil motor to push the slider toward the inside diameter to a slider stopping position from the slider parked position.

The invention's hard disk drive includes the embedded circuit supplying the voice coil control signal to the voice coil motor to park the slider on the disk surface. Manufacturing the hard disk drive includes electrically coupling the embedded circuit to the voice coil motor to supply the voice coil control signal to create the hard disk drive. The invention also includes the hard disk drive as a product of this manufacturing process.

### BRIEF DESCRIPTION OF THE DRAWINGS

FIG. 1A shows a slider with an air bearing surface and a trailing edge including the read-write head;

FIG. 1B shows some details of the invention's operation of starting the disks;

FIG. 1C shows some details of the invention's operation of stopping the disks; and

FIG. 2 shows some details of various aspects of the hard disk drive;

FIGS. 3 to 6C show some details of the embedded circuit implementing the invention's method in the hard disk drive;

FIG. 7A and 8 show some details of the hard disk drive;

FIG. 7B shows some details of the head gimbal assembly;

FIG. 10A shows the tab ramp which may be used in certain embodiments of the hard disk drive;

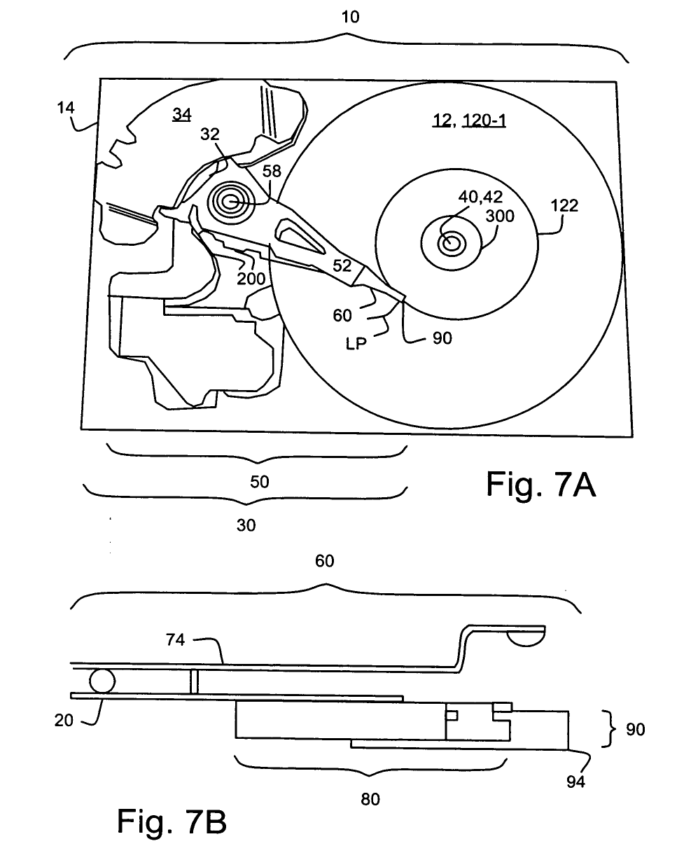

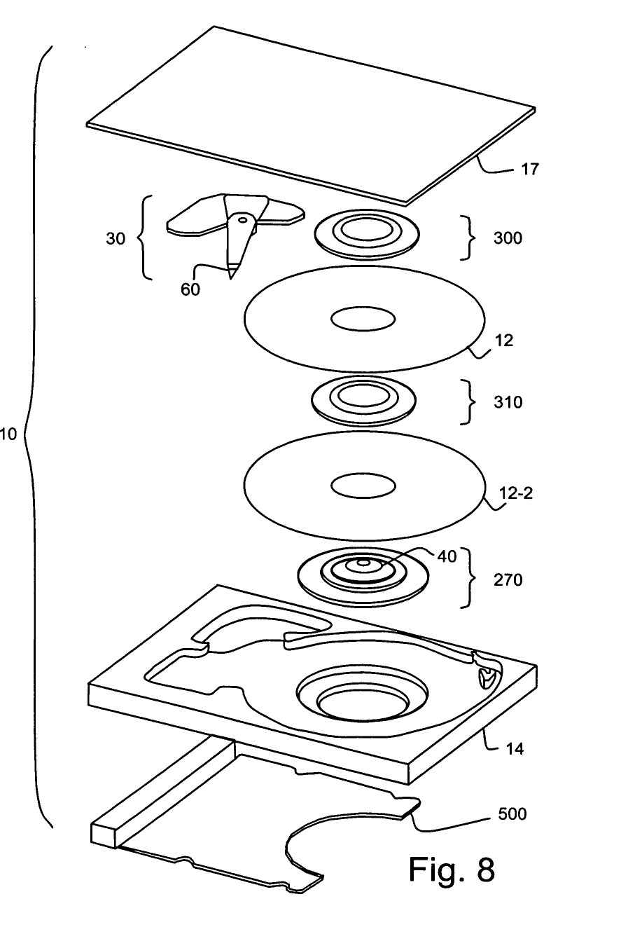

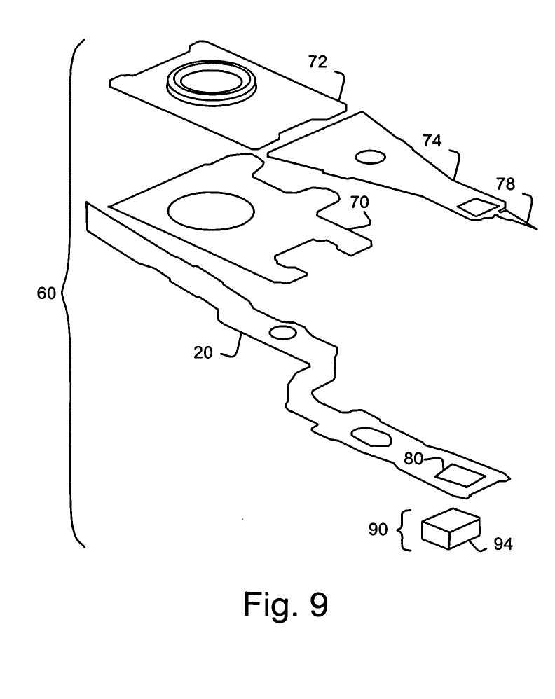

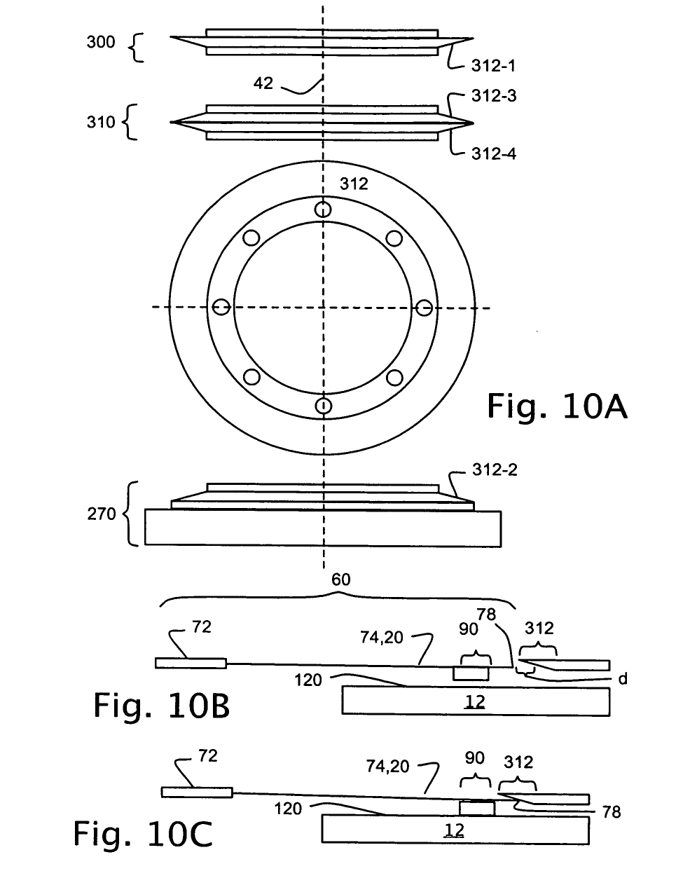

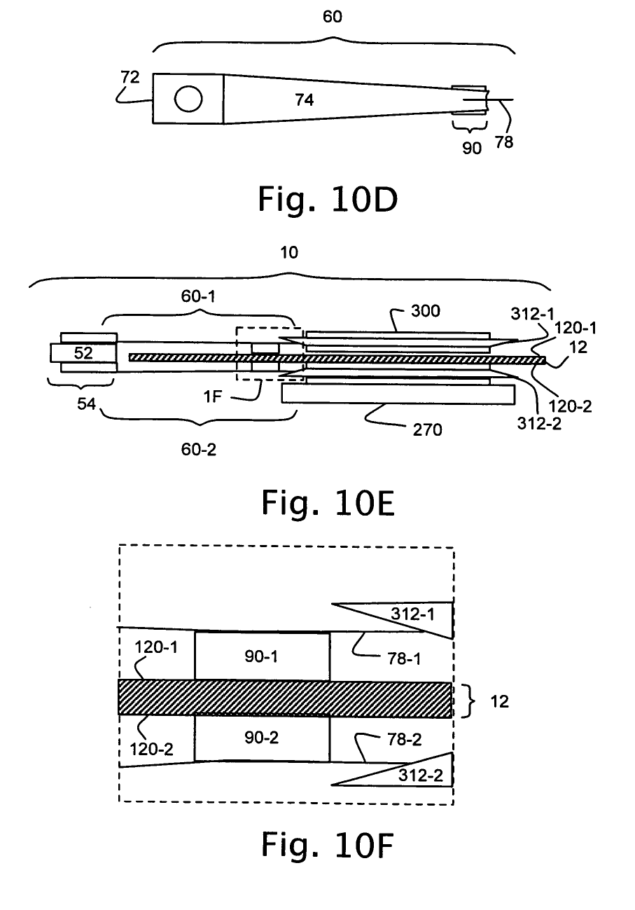

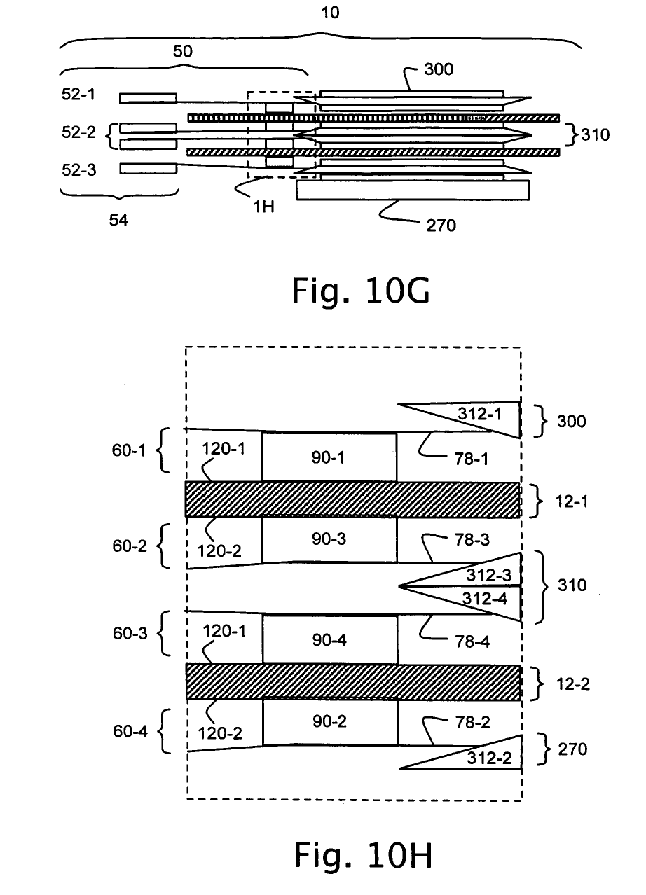

FIGS. 9, and 10B to 10D show some details of the use of a load tab on the head gimbal assembly of FIG. 7B; and

FIGS. 10E to 10H show some details of the hard disk drive using the load tab and tab ramp.

### DETAILED DESCRIPTION

The invention relates to Contact Start-Stop (CSS) hard disk drives. From hereon, a hard disk drive will be assumed to be a CSS hard disk drive. These hard disk drives are faced with several problems, some of which occur while a hard disk drive is not operating as a memory access device, which will be known herein as its non-operational mode. This invention relates to apparatus and methods of operating a Contact Start-Stop hard disk drive, especially after being damaged by mechanical shocks in a non-operational mode, when the sliders are parked on the disk surfaces of the hard disk drive.

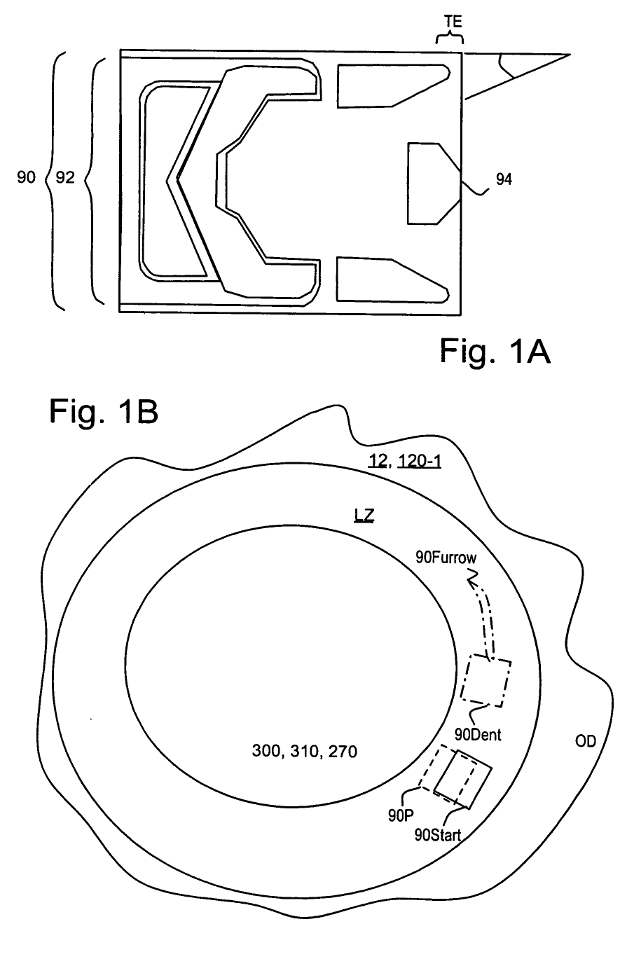

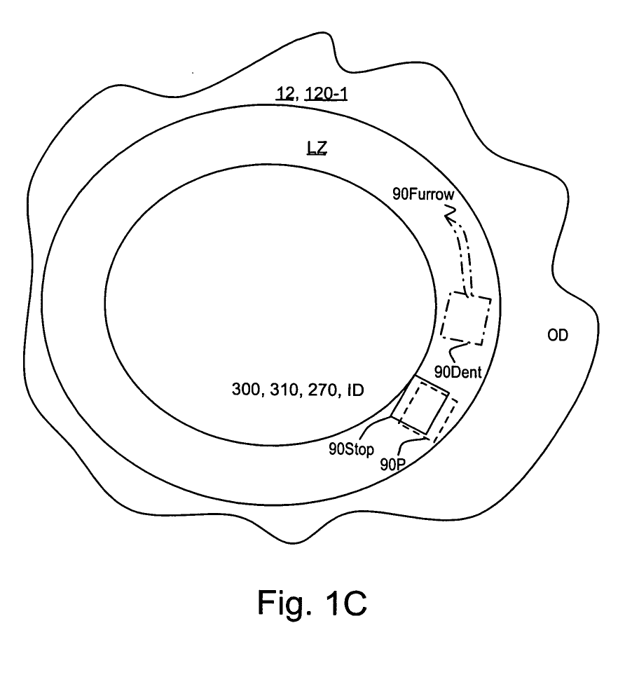

The invention operates a hard disk drive 10 by starting 160 at least one disk 12 using a starting stimulus 162 presented to a voice coil driver 30D to create a voice coil control signal 22 supplied to the voice coil motor 30 to push at least one slider 90 to a slider starting position 90Start from a slider parked position 90P. The invention improves contact start-stop durability for the hard disk drives, especially for hard disk drives damaged by non-operating shock. It improves CSS durability and decreases the probability of read-write head 94 degradation resulting from start-stop cycling after non-operating shock damage for hard disk drives where the slider is normally positioned directly over the dents 90Dent and their furrows 90Furrow in the landing zone LZ as shown in FIG. 1B.

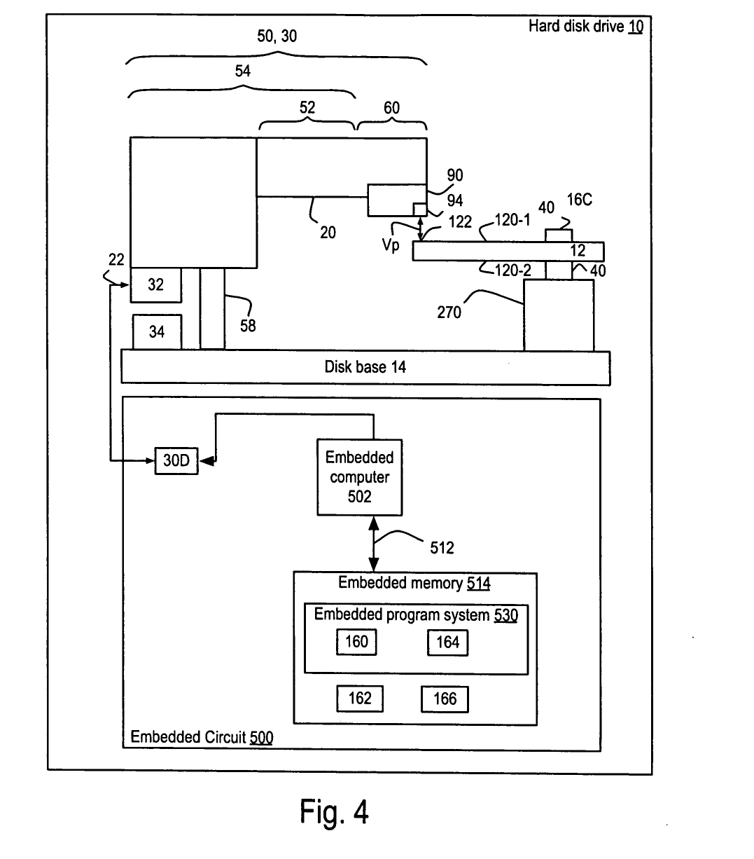

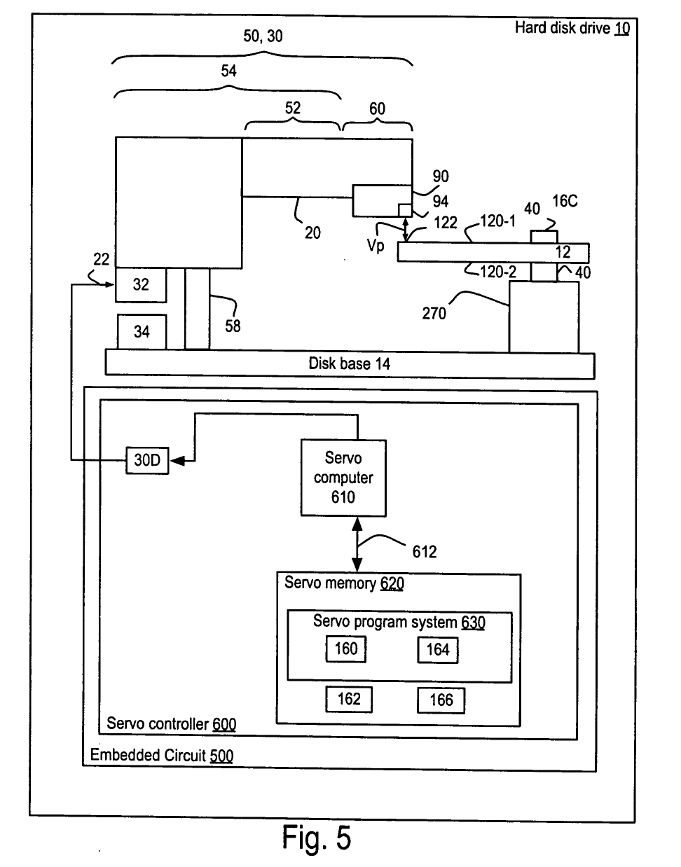

The invention improves contact start-stop durability for a hard disk drive 10, especially for one damaged by non-operating shock. The invention can be implemented through software changes in a program system, such as the embedded program system 530 as shown in FIG. 4 and/or the servo program system 630 as shown in FIG. 5, at little development cost and no increase in cost of materials for the hard disk drive. It may preferably improve CSS durability and decrease the probability of read-write head 94 degradation resulting from start-stop cycling after non-operating shock damage for hard disk drives where the read-write head is normally positioned directly over at least one dent 90Dent and their furrows in the landing zone LZ as shown in FIGS. 1A to 1C.

The invention may further include stopping 164 the at least one disk 12 using a stopping stimulus 166 presented to the voice coil driver 30D to drive the voice coil control signal 22 supplied to the voice coil motor 30 to push the slider 90 while the disk spindle decelerates to rest. Stopping the disk may further include stopping the disk using the stopping stimulus presented the voice coil driver to create the voice coil control signal supplied to the voice coil motor to push the slider toward the inside diameter ID to a slider stopping position 90Stop from the slider parked position 90P, as shown in FIG. 1C.

The distance between the slider starting position 90Start and the slider parked position 90P may be at most one millimeter, and preferably about half millimeter. The distance between the slider stopping position 90Stop and the slider parked position 90P may be at most half millimeter and preferably about a quarter millimeter.

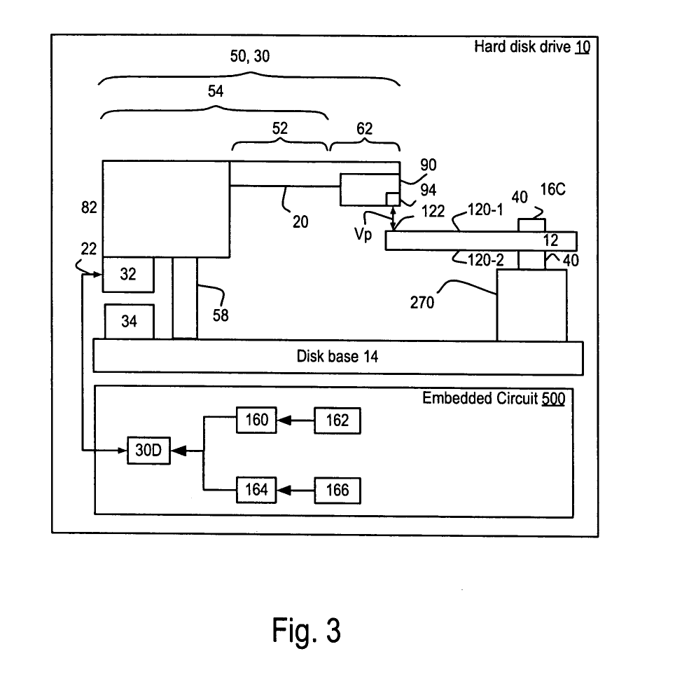

The invention includes an embedded circuit 500 for operating the hard disk drive 10, including means for starting 160 the disk 12 using the starting stimulus 162 presented to the voice coil driver 30D to create the voice coil control signal 22, where the voice coil control signal is supplied to the voice coil motor 30 to push the slider 90 to the slider starting position 90Start from the slider parked position 90P above a disk surface 120-1 included in the disk, as shown in FIGS. 3 to 6C.

The embedded circuit 500 may further include means for stopping 164 by using a stopping stimulus 166 presented the voice coil driver 30D to drive the voice coil control signal 22 supplied to the voice coil motor 30 to push the slider 90 while the disk spindle decelerates to rest. The means for stopping may further preferably include means for stopping the disk using the stopping stimulus presented the voice coil driver to create the voice coil control signal supplied to the voice coil motor to push the slider toward the inside diameter ID to the slider stopping position 90Stop from the slider parked position 90P.

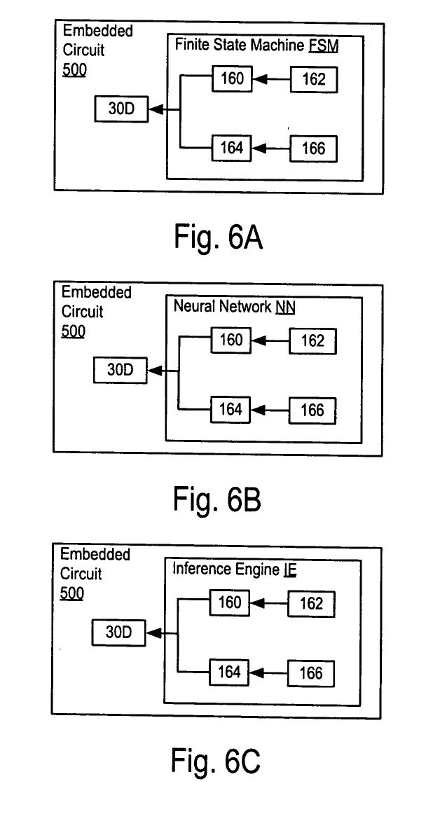

The embedded circuit 500 may include an implementation of the means for starting 160 including at least one of the following. A servo computer 610 presenting the starting stimulus 162 to the voice coil driver 30D and servo accessibly coupled 612 to a servo memory 620 and directed by a servo program system 630 including at least one program step residing in the servo memory as shown in FIG. 4. An embedded computer 502 presenting the starting stimulus to the voice coil driver and embedded accessibly coupled 512 to an embedded memory 514 and directed by an embedded program system 530 including at least one program step residing in the embedded memory as shown in FIG. 5. A finite state machine FSM presenting the starting stimulus to the voice coil driver as shown in FIG. 6A. A neural network NN presenting the starting stimulus to the voice coil driver as shown in FIG. 6B. And/or an inference engine IE presenting the starting stimulus to the voice coil driver as shown in FIG. 6C.

The servo computer 610 may preferably perform real time control of the spindle motor 270 and the voice coil motor 30 to rotate the disk 12 and position the head stack assembly 50 so that the slider 90 and its read-write head 94 are properly positioned with the rotating disk surface 120-1. Often the servo computer also real-time controls the micro-actuator 80 providing positioning refinements, particularly when the read-write head is trying to access a track 122 in what is referred to as track-following mode.

The embedded computer 502 may preferably act to control the writing and reading of the data in a track 122, often involving signal compensation, error detection and correction techniques, as well as provide translations between the logical track numbers and the physical track locations.

As used herein, a computer, for example the servo computer 610 and/or the embedded computer 502 may each include at least one instruction processor and at least one data processor. Each data processor is directed by at least one instruction processor. The computer may be implemented in, or as, a Field Programmable Gate Array, gate array, an application specific integrated circuit, a digital signal processor, a system of a chip (SOC) and/or a general-purpose microprocessor.

The finite state machine 502 may be implemented by any combination of: a logic circuit, a programmable logic device, and/or a Field Programmable Gate Array. The logic circuit may be implemented in a gate array and/or an application specific integrated circuit.

The neural network 530 may be implemented similarly to the finite state machine 502, and include neurons, each with a neural state and coupling through weighted paths to other neurons.

The invention includes manufacturing the embedded circuit 500, by providing the means for starting 160 to create the embedded circuit. Manufacturing may also include providing the means for stopping 164 to further create the embedded circuit. The invention includes the embedded circuit as a product of this process.

Providing the means for starting 160 may further include at least one of the following. Providing the servo computer 610 presenting the starting stimulus 162 to the voice coil driver 30D and servo accessibly coupled 612 to the servo memory 620 and directed by the servo program system 630 including at least one program step residing in the servo memory. Providing the embedded computer 502 presenting the starting stimulus 162 to the voice coil driver 30D and embedded accessibly coupled 512 to the embedded memory 514 and directed by the embedded program system 530 including at least one program step residing in the embedded memory. Providing the finite state machine FSM presenting the starting stimulus to the voice coil driver. Providing the neural network NN presenting the starting stimulus to the voice coil driver. And providing the inference engine IE presenting the starting stimulus to the voice coil driver.

Providing the servo computer 610 may further include providing at least one of the program steps in a non-volatile memory component of the servo memory 620. Providing the embedded computer, may further include providing the at least program step in a non-volatile memory component of the embedded memory. As used herein a non-volatile memory component retains its memory contents with being provided with power, whereas a volatile memory component requires a supply of power on at least an irregular basis to retain its memory contents.

The servo program system 630 and/or the embedded program system 530, may include a program step supporting starting 160 the at least one disk 12 using the starting stimulus 162 presented to the voice coil driver 30D to create the voice coil control signal 22 supplied to the voice coil motor 30 to push the at least one slider 90 to the slider starting position 90Start from the slider parked position 90P.

The servo program system 630 and/or the embedded program system 530, may include a program step supporting stopping 164 the disk 12 using a stopping stimulus 166 presented the voice coil driver 30D to drive the voice coil control signal 22 supplied to the voice coil motor 30 to push the slider 90 while the disk spindle decelerates to rest, possibly further supporting stopping the disk using the stopping stimulus presented the voice coil driver to create the voice coil control signal supplied to the voice coil motor to push the slider toward the inside diameter ID to a slider stopping position 90Stop from the slider parked position 90P.

The invention's hard disk drive 10 may include the embedded circuit 500 supplying the voice coil control signal 22 to the voice coil motor 30 to park the slider on the disk surface 120-1. Manufacturing the hard disk drive includes electrically coupling the embedded circuit to the voice coil motor to supply the voice coil control signal to create the hard disk drive. The invention also includes the hard disk drive as a product of this manufacturing process.

The invention applies to a hard disk drive 10 where at least one slider 90 are positioned directly over a dent 90Dent produced by the slider when in its slider parked position 90P. The dent may preferably be caused by the trailing edge TE and/or by the leading edge corner of the air bearing surface 92 of the slider. Even a small (0.2 mm) shift in slider position relative to its position during the shock event would relieve greatly both the rate of disk wear, and especially damage on the head. The trailing edge, includes the read-write head 94 and flies the lowest and consequently creates the greatest contact pressures when sliding on a furrow 90Furrow. By moving the slider so that the furrows pass beside the trailing edge, then only the leading pads of the air bearing surface contact the furrows, creating relatively low contact pressures and wear rates. This shift in position also precludes the read-write head from directly contacting the furrows, thus saving this delicate structure from potential damage.

The slider 90 position during shock damage is determined by the inside diameter ID crash-stop/latch position while no power is supplied to the hard disk drive 10, which will be referred to herein as the slider parked position 90P. The inventors recognized that the materials comprising the crash stop are pliant, allowing changes in the slider position by altering the compressive force applied to the crash-stop/latch. The invention involves changing this compressive force through power applied by the voice coil control signal 22 to the voice coil motor 30.

The hard disk drive 10 may include a means for starting 160 the disks using a starting stimulus 162 presented a voice coil driver 30D to drive the voice coil control signal 22 supplied to the voice coil 32 of the voice coil motor 30 to push the slider 90 toward the outside diameter OD, reducing compressive stress in the crash-stop/latch and moving the sliders relative to their slider parked position 90P during non-operating conditions to a slider starting position 90Start as shown in FIGS. 1B, 3, 4, and 5. Inspecting the behavior of a contemporary hard disk drive 10 showed that displacements of more than 0.5 mm are possible without releasing the latch. After full disk speed is reached, a current pulse is applied the voice coil control signal to break the latch free.

The hard disk drive 10 may include a means for stopping 164 the disks using a stopping stimulus 166 presented the voice coil driver 30D to drive the voice coil control signal 22 supplied to the voice coil motor 30 to push the slider 90 while the disk spindle 40 decelerates to rest. This power can be made available through motor back-EMF, which is a power source utilized to ensure proper latching of load-unload drive designs.

As an alternative embodiment, voice coil control signal 22 is supplied to the voice coil motor 30 to push the slider(s) toward the disk inside diameter ID to a slider stopping position 90Stop, as shown in FIGS. 1C, 3, 4, and 5, increases compressive stress in the crash-stop/latch and moving the sliders relative to their slider parked position 90P during non-operation conditions. The inventors found that displacements of 0.2 mm are possible with this technique on an existing hard disk drive 10, where the displacement is sufficient to reduce the rate of damage on read-write head 90 and the disk 12.

The voice coil motor 30 may preferably have a bias applied to shift the slider approximately 250 micrometer toward the outside diameter OD.

The hard disk drive 10 may include head gimbal assemblies 60 with a load tab 78 coupling through a load beam 74 to contact a tab ramp 312 when the slider 90 is in the slider parked position 90P, as shown in FIG. 10C. The means for starting 160 the disk 12 may act to move the slider to the slider starting position 90Start as shown in FIG. 10B. The means for stopping 164 may act to move the slider to the slider stopping position 90Stop, also shown as FIG. 10B.

As used herein a program step supporting the step of a method may preferably refer to at least one of the following. The instruction processor responds to a method's step as the program step to control the data execution unit in at least partly implementing the step. The inferential engine responds to the step as nodes and transitions within an inferential graph based upon and modifying an inference database in at least partly implementing the step. The neural network responds to the step as stimulus in at least partly implementing the step. The finite state machine responds to the step as at least one member of a finite state collection comprising a state and a state transition, implementing at least part of the step.

The hard disk drive 10 normally operates starts accessing a track 122 on a disk surface 120-1 and positions the slider for starting and stopping the spindle motor 270 and spindle shaft 40 as follows. The embedded circuit 500, frequently the servo controller 600, and quite frequently the servo computer 610 stimulate the voice coil driver 30D to generate the voice coil control signal 22, which is presented to the voice coil 32 in the voice coil motor 30. The voice coil control signal is preferably in the form of a time varying electrical signal stimulating the voice coil to induce a time varying magnet field, which interacts with the fixed magnet 34. This interaction generates a mechanical force which acts through head stack assembly 50 pivoting about the actuator pivot 58 mounted on the disk base 14 to move the head gimbal assembly 60. In greater detail, head stack assembly further moves the slider and its read-write head 94 based upon the voice coil 32 and its rigid coupling to the actuator arm 52 and its coupling to the head gimbal assembly.

The head gimbal assembly 60 typically includes the slider 90 coupling through a flexure finger 20 to the load beam 74 as shown in FIGS. 3 to 5, 7B and 9. The load beam couples through a hinge 70 to the base plate 72. The head gimbal assembly is typically coupled to the head stack assembly 50 through an actuator arm 52, often through the use of a swaging process. The flexure finger may include a micro-actuator 80 and/or the slider may include a micro-actuator. Either and/or both micro-actuator may employ a piezoelectric effect and/or a thermal-mechanical effect and/or an electrostatic effect. Either and/or both may affect the lateral position LP of the slider and its read-write head 94, and/or affect the vertical position VP of the slider off the rotating disk surface 120-1. This invention is focused on the lateral positioning of the slider, and while vertical positioning is not considered a strong element of this invention, it is mentioned to clarify the scope of this invention.

The hard disk drive 10 may implement a method of parking the sliders which includes, for each head gimbal assembly 60 included in a hard disk drive 10, the head gimbal assembly interacts with a tab ramp 312 radially mounted about a spindle shaft center 42 as follows. A load tab 78 included in the head gimbal assembly contacts the tab ramp to engage the slider 90 into a secure contact with a disk surface 120, as shown in FIGS. 10C, and 10E to 10H. The disk surface is included in a disk 12 mounted through the spindle shaft center. The disk surface may include a disk substrate of nickel-phosphorus clad aluminum.

The head gimbal assembly 60, may includes the load tab 78 coupling through a load beam 74 to engage the slider 90, where the load tab contacts the tab ramp away from the slider, as shown in FIG. 10C. In the prior art, the load tab contacts a load ramp toward the slider, to lift the slider away from the disk surface, rather than securing contact with it.

FIG. 10A shows various embodiments of the invention's tab ramp 312. These ramps serve as a cam through contacting the load tabs of head gimbal assemblies to engage their sliders into secure contact with their neighboring disk surfaces during non-operation periods.

The hard disk drive 10 may include a disk clamp 300 supporting this method of parking the sliders on disk surfaces by including a third tab ramp 312-3 as shown in FIG. 10A.

The hard disk drive may include a spindle motor 270 supporting this method of parking the sliders on disk surfaces by including a fourth tab ramp 312-4.

The hard disk drive may include a disk spacer 310 supporting this method of parking the sliders on disk surfaces by including a third tab ramp 312-3 radially mounted to a fourth tab ramp 312-4, which form a radially symmetric triangular extension from the disk spacer about the spindle shaft center 42.

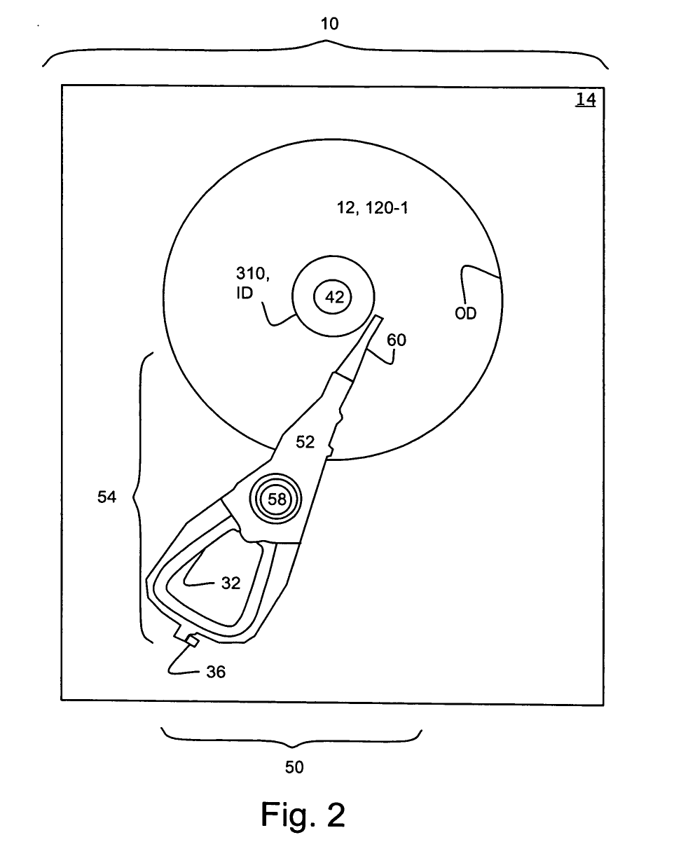

The hard disk drive 10 may implement this method of parking the sliders on disk surfaces, by including at least one disk surface 120, for example a first disk surface 120-1 for access by at least one head gimbal assembly 60, for example a first head gimbal assembly 60-1 including the first load tab 78-1 for contact with the first tab ramp 312-1 near a far inside diameter ID of the disk surface as shown in FIG. 2A.

The hard disk drive 10 may further include a second disk surface 120-2 for access by a second head gimbal assembly 60-2 including a third load tab 78-3 for contact with a third tab ramp 312-3 near the far inside diameter ID of the second disk surface. The hard disk drive may further include a disk clamp 300 containing the first tab ramp 312-1 and a spindle motor 270 containing the second tab ramp 312-2.

The preceding embodiments provide examples of the invention and are not meant to constrain the scope of the following claims.

What is claimed is:

1. A method of operating a contact start-stop hard disk drive, comprising the step:
starting at least one disk using a starting stimulus presented to a voice coil driver to create a voice coil control signal supplied to the voice coil motor to push at least one slider to a slider starting position from a slider parked position.

2. The method of claim 1, wherein a distance between said slider starting position and said slider parked position is at most one millimeter.

3. The method of claim 1, further comprising the step:
stopping said at least one disk using a stopping stimulus presented to said voice coil driver to drive said voice coil control signal supplied to said voice coil motor to push said slider while the disk spindle decelerates to rest.

4. The method of claim 3, wherein the step stopping, further comprises the step:
stopping said at least one disk using said stopping stimulus presented said voice coil driver to create said voice coil control signal supplied to said voice coil motor to push said slider toward the inside diameter to a slider stopping position from said slider parked position.

5. The method of 4, wherein a distance between said slider stopping position and said slider parked position is at most one half millimeter.

6. An embedded circuit for operating said contact start-stop hard disk drive of claim 1, comprising:
means for starting said at least one disk using said starting stimulus presented to said voice coil driver to create said voice coil control signal;
wherein said voice coil control signal is supplied to said voice coil motor to push said at least one slider to said slider starting position from said slider parked position above a disk surface included in said disk.

7. The embedded circuit of claim 6, further comprising:
means for stopping said at least one disk using a stopping stimulus presented said voice coil driver to drive said voice coil control signal supplied to said voice coil motor to push said slider while the disk spindle decelerates to rest.

8. The embedded circuit of claim 7, wherein the means for stopping, further comprises:
means for stopping said at least one disk using said stopping stimulus presented said voice coil driver to create said voice coil control signal supplied to said voice coil motor to push said slider toward the inside diameter to said slider stopping position from said slider parked position.

9. The embedded circuit of claim 6, wherein said means for starting is implemented with at least one member of the group consisting of:
a servo computer presenting said starting stimulus to said voice coil driver and accessibly coupled to a servo memory and directed by a servo program system including at least one program step residing in said servo memory;
an embedded computer presenting said starting stimulus to said voice coil driver and accessibly coupled to an embedded memory and directed by an embedded program system including at least one program step residing in said embedded memory;
a finite state machine presenting said starting stimulus to said voice coil driver;
a neural network presenting said starting stimulus to said voice coil driver; and
an inference engine presenting said starting stimulus to said voice coil driver.

10. A method of manufacturing said embedded circuit of claim 6, comprising the step:
providing said means for starting to create said embedded circuit.

11. The method of claim 10, wherein the step providing said means for starting, further comprises at least one member of the group consisting of the steps:
providing a servo computer presenting said starting stimulus to said voice coil driver and accessibly coupled to a servo memory and directed by a servo program system including at least one program step residing in said servo memory;
providing an embedded computer presenting said starting stimulus to said voice coil driver and accessibly coupled to an embedded memory and directed by an embedded program system including at least one program step residing in said embedded memory;
providing a finite state machine presenting said starting stimulus to said voice coil driver;
providing a neural network presenting said starting stimulus to said voice coil driver; and
providing an inference engine presenting said starting stimulus to said voice coil driver.

12. The method of claim 11,
wherein the step providing said servo computer, further comprises the step: providing said at least program step in a non-volatile memory component of said servo memory; and
wherein the step providing said embedded computer, further comprises the step: providing said at least program step in a non-volatile memory component of said embedded memory.

13. The method of claim 11, wherein for at least one member of the group consisting of: said servo program system and said embedded program system, said member includes the program step:
starting said at least one disk using said starting stimulus presented to said voice coil driver to create said voice coil control signal supplied to the voice coil motor to push said at least one slider to said slider starting position from said slider parked position.

14. The embedded circuit as a product of the process of claim 10.

15. The contact start-stop hard disk drive of claim 6, comprising:
said embedded circuit supplying said voice coil control signal to said voice coil motor to park said slider on said disk surface.

16. A method of manufacturing said contact start-stop hard disk drive of claim 15, comprising the step:
electrically coupling said embedded circuit to said voice coil motor to supply said voice coil control signal to create said contact start-stop hard disk drive.

17. The contact start-stop hard disk drive as a product of the process of claim 16.

18. The contact start-stop hard disk drive of claim 15, further comprising: a head gimbal assembly including a load tab coupling through a load beam to engage said slider into a secure contact with said disk surface at said slider parked position when said load tab contacts a tab ramp radially arranged about a spindle shaft center.

19. The hard disk drive, further comprising: a second disk surface included in said disk.

20. The hard disk drive, further comprising: a second disk.
